(19) United States
(12) Patent Application Publication
(10) Pub. No.: US 2020/0195071 A1
(43) Pub. Date: Jun. 18, 2020

(54) ROTOR HAVING STRUCTURAL OPTIMIZATION

(71) Applicant: GM Global Technology Operations LLC, Detroit, MI (US)

(72) Inventors: Alireza Fatemi, Canton, MI (US); Anthony M. Coppola, Rochester Hills, MI (US); Thomas W. Nehl, Shelby Township, MI (US)

(73) Assignee: GM Global Technology Operations LLC, Detroit, MI (US)

(21) Appl. No.: 16/219,073

(22) Filed: Dec. 13, 2018

(51) Int. Cl. H02K 1/27; H02K 1/28; H02K 15/03

(52) U.S. Cl. CPC H02K 1/2766; H02K 2201/03; H02K 15/03; H02K 1/28

(57) ABSTRACT

Systems, methods, and devices including a rotor body including a curable material are described. The rotor body includes a plurality of ferromagnetic components arranged about an axis defining a circular periphery distal to the axis and a plurality of flux barriers. The plurality of ferromagnetic components define a plurality of channels arranged circumferentially about the axis. Each of the plurality of flux barriers includes a curable filler occupying a respective one of the plurality of channels. The curable filler is configured to maintain radial spacing of the plurality of ferromagnetic components and optimize mechanical stress across the rotor body.

### INTRODUCTION

The present disclosure relates generally to electric machines. More specifically, aspects of this disclosure relate to rotors for electric motors.

Rotary electric machines, such as motor-generator units, include a rotor body configured to rotate about an axis. During rotation, the rotor body experiences tensile stresses. The rotor body includes flux barriers therein, which affect tensile stresses through the body. More particularly, structural features used to maintain the positioning of the flux barriers experience focused stresses and affect magnetic properties of the rotor body.

### SUMMARY

Rotor bodies according to aspects of the present disclosure provide a number of benefits. For example, rotor bodies as disclosed herein optimize performance of the motor-generator though, for example, (1) strengthened magnetic interactions between the ferromagnetic components of the rotor body and electromagnetic components of the stator body by reducing space between a periphery of rotor body and inner surface of the stator, (2) reducing thickness of or eliminating non-magnetic components disposed between magnetic components of the rotor body and magnetic components of the stator, such as sleeves or wraps, and/or (3) reducing thickness of or eliminating flux-leaking components of the rotor body disposed proximate the stator body. Further, rotor bodies in accordance with the present disclosure provide for an increased number of flux barriers within the same space while maintaining or increasing structural integrity of the rotor body. Moreover, efficiency and peak rotational speeds are optimized by the curable filler providing structural integrity to the rotor body and thereby maintaining structural integrity of the rotor body at high RPM. Beneficially, rotor bodies in accordance with the present disclosure further optimize structural integrity during revolution of the rotor body by reducing rotor weight.

According to aspects of the present disclosure, a rotor body includes a plurality of ferromagnetic components arranged about an axis defining a circular periphery distal to the axis and a plurality of flux barriers. The plurality of ferromagnetic components define a plurality of channels arranged circumferentially about the axis. Each of the plurality of flux barriers includes a curable filler occupying a respective one of the plurality of channels. The curable filler is configured to maintain radial spacing of the plurality of ferromagnetic components and optimize mechanical stress across the rotor body.

According to further aspects of the present disclosure, the circular periphery is a continuous circular periphery defined by the ferromagnetic components and the curable filler.

According to further aspects of the present disclosure, the rotor body further includes a non-magnetic overwrap circumscribing the circular periphery.

According to further aspects of the present disclosure, the curable filler is an epoxy, a phenol, a silicone, or a polyurethane.

According to further aspects of the present disclosure, at least one of the plurality of flux barriers includes a profiled edge, the profiled edge provides a mechanical interlock between the curable filler and the ferromagnetic components.

According to further aspects of the present disclosure, the profiled edge includes alternating protruding portions and recessed portions.

According to further aspects of the present disclosure, the profiled edge includes undercuts therealong.

According to further aspects of the present disclosure, the rotor body further includes at least one permanent magnet disposed within the curable filler within the plurality of flux barriers

According to aspects of the present disclosure, a motor-generator includes a rotor body with a plurality of ferromagnetic components and a plurality of flux barriers, and a stator circumscribing the rotor body. The plurality of ferromagnetic components is arranged about an axis defining a circular periphery distal to the axis. The plurality of ferromagnetic components defines a plurality of channels arranged circumferentially about the axis. Each of the plurality of flux barriers includes a curable filler occupying a respective one of the plurality of channels. The curable filler configured to maintain radial spacing of the plurality of ferromagnetic components and optimize mechanical stress across the rotor body.

According to further aspects of the present disclosure, the circular periphery is a continuous circular periphery defined by the ferromagnetic components and the curable filler.

According to further aspects of the present disclosure, the motor-generator further includes an air gap defined by the continuous circular periphery and the stator body.

According to further aspects of the present disclosure, the motor-generator further includes an overwrap circumscribing the rotor body and an air gap defined by an outer periphery of the overwrap and an interior of the stator body.

According to aspects of the present disclosure, a method includes arranging a plurality of ferromagnetic components to thereby form a rotor-body precursor defining a plurality of channels therein; filling the plurality of channels with a curable filler to thereby form a plurality of flux barriers; and curing the curable filler to thereby form a rotor body.

According to further aspects of the present disclosure, the plurality of ferromagnetic components are suspended, prior to filling the plurality of channels, by one or more of a plurality of ferrous bridges and a plurality of central posts.

According to further aspects of the present disclosure, the method further includes removing, after curing, a plurality of ferrous bridges disposed about a periphery of the rotor body to thereby produce a continuous circular periphery defined by the ferromagnetic components and the curable filler.

According to further aspects of the present disclosure, the method further includes applying an overwrap to the rotor body, the overwrap circumscribing and contacting a continuous circular periphery defined by the ferromagnetic components and the curable filler.

According to further aspects of the present disclosure, the rotor-body precursor is a laminated rotor-body precursor, and the laminated rotor-body precursor does not include a plurality of ferrous bridges disposed about a periphery.

According to further aspects of the present disclosure, the method further includes aligning the rotor body with a stator body to define an air gap therebetween.

According to further aspects of the present disclosure, the rotor body includes a continuous circular periphery defined by the ferromagnetic components and the curable filler in response to curing the curable filler.

According to further aspects of the present disclosure, at least one of the plurality of channels includes a profiled edge, and wherein the profiled edge, in response to curing the curable filler provides a mechanical interlock between the curable filler and the ferromagnetic components.

According to further aspects of the present disclosure, the profiled edge includes alternating protruding portions and recessed portions.

The above summary is not intended to represent every embodiment or every aspect of the present disclosure. Rather, the foregoing summary merely provides an exemplification of some of the novel concepts and features set forth herein. The above features and advantages, and other features and attendant advantages of this disclosure, will be readily apparent from the following detailed description of illustrated examples and representative modes for carrying out the present disclosure when taken in connection with the accompanying drawings and the appended claims. Moreover, this disclosure expressly includes any and all combinations and subcombinations of the elements and features presented above and below.

### BRIEF DESCRIPTION OF THE DRAWINGS

FIG. 1 is a schematic illustration of a representative vehicle with a rotor body in accordance with aspects of the present disclosure.

FIG. 2 is a schematic side-view illustration of a representative electric machine with a rotor body in accordance with aspects of the present disclosure.

FIG. 3A is a partially exploded schematic illustration of a laminated rotor body in accordance with aspects of the present disclosure.

FIG. 3B is a partially exploded schematic illustration of another laminated rotor body in accordance with aspects of the present disclosure.

FIGS. 4A-D are plan views of rotor body plates in accordance with aspects of the present disclosure.

FIG. 5 is a method of making a rotor body in accordance with aspects of the present disclosure.

The present disclosure is amenable to various modifications and alternative forms, and some representative embodiments are shown by way of example in the drawings and will be described in detail herein. It should be understood, however, that the novel aspects of this disclosure are not limited to the particular forms illustrated in the above-enumerated drawings. Rather, the disclosure is to cover all modifications, equivalents, combinations, subcombinations, permutations, groupings, and alternatives falling within the scope of this disclosure as encompassed by the appended claims.

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, and Detailed Description sections, but not explicitly set forth in the claims, should not be incorporated into the claims, singly or collectively, by implication, inference or otherwise.

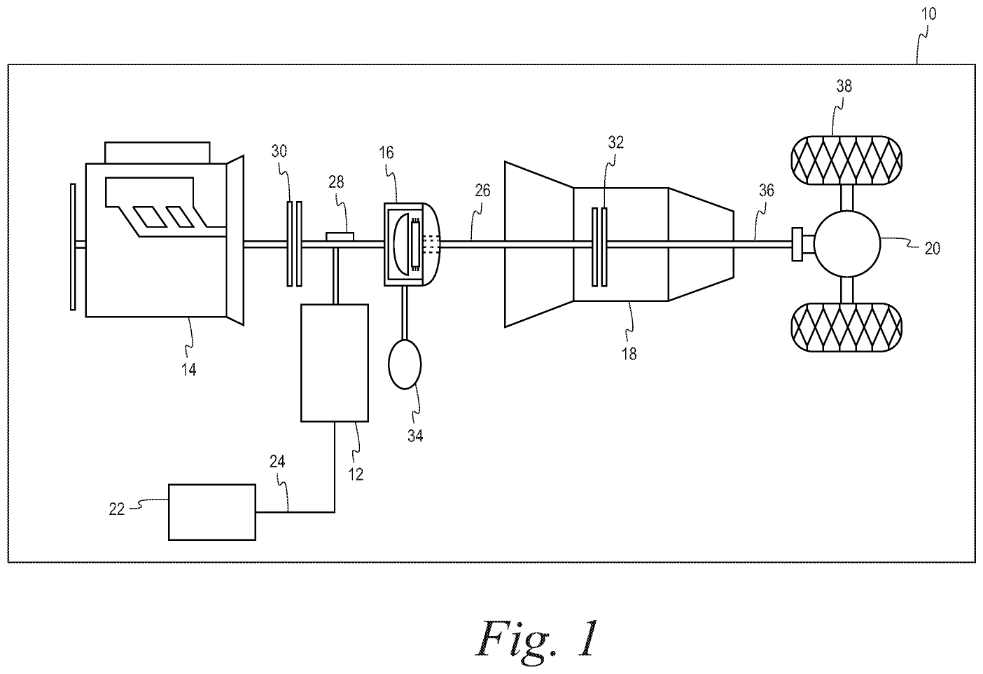

FIG. 1 is a schematic illustration of a vehicle 10 including a motor-generator 12, which is configured to propel the vehicle 10 alone and/or in concert with another power source, such as an engine 14. The vehicle 10 may be, for example, a hybrid electric vehicle, plug-in hybrid electric vehicle, range-extended hybrid electric vehicle, fuel-cell electric vehicle, fuel cell hybrid electric vehicle, or the like. The illustrated vehicle 10 includes a hybrid powertrain with the motor-generator 12, the engine 14, a torque converter 16, a transmission 18, and a final drive 20. The hybrid powertrain may be, for example, parallel (e.g., P1-P4) hybrid powertrains, a power-split (“PS”) hybrid powertrain, or the like.

The motor-generator 12 is configured to convert between electrical power and mechanical power. The motor-generator 12 may be selectively actuated to propel the vehicle 10 or charge the power source. The motor-generator 12 is operatively coupled to an electrical power source, such as battery pack 22, via conductors 24 configured to transmit electrical energy therebetween.

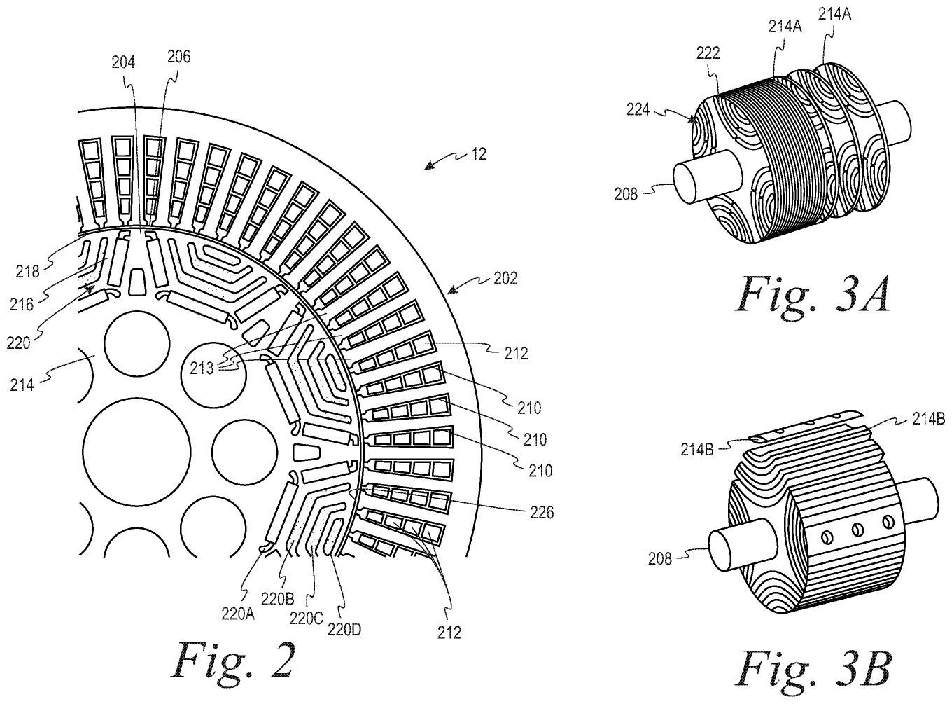

The motor-generator 12 is also operatively coupled to a transmission input 26 via a motor output 28 configured to transmit mechanical energy therebetween. As will be explained further below with reference to FIG. 2, the motor-generator 12 includes a stator 202 and a rotor body 204 within a motor body. In some aspects, the vehicle 10 has a single motor-generator 12, while in other aspects, the vehicle 10 has a plurality of motor-generators 12.

The engine 14 is configured to burn a fuel to produce mechanical power. The engine 14 may be a suitable internal combustion engine, such as a two or four-stroke compression-ignited diesel engine or a four-stroke spark-ignited gasoline or flex-fuel engine, which is readily adapted to provide its available power output typically at a number of revolutions per minute (RPM). In some aspects, the vehicle 10 has a single engine 14, while in other aspects, the vehicle 10 includes a plurality of engines 14.

In the illustrated example, the engine 14 is coupled to an engine-disconnect clutch 30. The engine-disconnect clutch 30 is configured to be selectively actuated to thereby transmit torque received from the engine 14 to an input structure of the torque converter 16.

The torque converter 16 is configured to optimize delivered torque based on differences in revolutions per minute (RPM) of the input and output. For example, the torque converter 16 may be a hydrokinetic device configured to increase torque that is received from, for example, the engine 14 or motor-generator 12 via, for example, when the output is at a lower RPM. Additionally or alternatively, the torque converter 16 may include a selectively actuatable mechanical device, such as a lock-up clutch, to form a mechanical coupling between the input and output of the torque converter 16.

The transmission 18 is configured to receive power from powerplants, such as the motor-generator 12 and/or engine 14, selectively manipulate the received power, such as through a selecting one of a plurality of gear ratios, and distributing the manipulated power to the final drive 20. The transmission 18 may be, for example, an automatic transmission, manual transmission, continuously variable transmission, combinations thereof, and the like.

The power transmission 18 may use differential gearing 32 to achieve selectively variable torque and speed ratios between the transmission input 26 and the driveshaft 36. For example, the differential gearing 32 may be an epicyclic planetary gear arrangement.

Hydraulically actuated torque establishing devices, such as clutches and brakes (referred to collectively and/or individually as a “clutch”), are selectively engageable via a hydraulic pump 34 to activate the aforementioned differential gearing to achieve desired forward and reverse speed ratios between the transmission input 26 and driveshaft 36 of the transmission 18.

The final drive 20 is configured to deliver torque to one or more wheels 38 of the vehicle. In some aspects, the final drive 20 is directly coupled to the transmission 18 via the driveshaft 36 such that power from the motor-generator 12 and/or engine 14 may be transmitted to one or more of the wheels 38 via the transmission 18. The final drive 20 may be, for example, a differential. The final drive 20 may take on numerous configurations, including front wheel drive, rear wheel drive, four-wheel drive, all-wheel drive, etc.

One or more of the illustrated powertrain components may be actuated or operated by an onboard or remote vehicle controller, such as programmable electronic control unit constructed and programmed to govern, among other things, operation of the engine 14, motor-generator 12, transmission 18, torque converter 16, clutches, combinations thereof, and the like. Control module, module, controller, control unit, processor, and permutations thereof may be defined to mean one or various combinations of one or more of logic circuits, application specific integrated circuit(s) (ASIC), electronic circuit(s), central processing unit(s) (e.g., microprocessor(s)), and associated memory and storage (e.g., read only, programmable read only, random access, hard drive, tangible, etc.)), combinational logic circuit(s), input/output circuit(s) and devices, etc., whether resident, remote, or a combination of both. The foregoing hardware may be configured to execute one or more software or firmware programs or routines, e.g., using appropriate signal conditioning and buffer circuitry, and other components to provide the described functionality. Software, firmware, programs, instructions, routines, code, algorithms and similar terms may be defined to mean controller-executable instruction sets, including calibrations and look-up tables. An electronic control unit may be designed with a set of control routines executed to provide the desired functions. Control routines are executed, such as by a central processing unit, and are operable to monitor inputs from sensing devices and other networked control modules, and execute control and diagnostic routines to control operation of devices and actuators. Routines may be executed in real-time, continuously, systematically, sporadically and/or at regular intervals during ongoing vehicle use. Alternatively, routines may be executed in response to occurrence of an event during operation of the vehicle 10.

Referring now to FIG. 2, portions of the motor-generator 12 are shown. The motor-generator 12 includes the rotor body 204 circumscribed by and concentric with the stator 202. Electric power is provided to the stator body 202 through electrical conductors 24 that pass through the motor body in suitable sealing and insulating feedthroughs (not illustrated) to thereby produce rotational motion of the rotor body 204. Conversely, mechanical power may be provided to the rotor body 204 to induce a current in the stator 202 and thereby provide electrical energy to the electrical power source, e.g., via regenerative breaking.

The stator body 202 may be, for example, a multi-phase stator assembly. The stator body 202 is coaxial with and radially surrounds the rotor body 204 while maintaining a space 206 therebetween. In some aspects, the space 206 is between about 0.2 millimeters (mm) and about 1.0 mm to thereby maximize power output while reducing likelihood of contact between the stator body 202 and the rotor body 204 during rotation thereof. The stator body 202 is generally annular along a longitudinal axis A of the rotor body 204. It should be appreciated that a protective motor body (not shown) may surround an outer periphery of the stator body 202 and may support the motor-generator shaft 208.

The stator body 202 may include multiple radially elongated, circumferentially spaced stator slots 210 (e.g., 60 total slots). The stator slots 210 extend through the stator body 202 longitudinally along the axis A. The stator slots 210 are configured to house electrically conductive, multiphase stator windings 212. The stator windings 212 may be grouped into different sets, each of which may carry an identical number of phases of electrical current, such as three, five, six, or seven phases. Passing current through the stator windings 212 will generate a magnetic field at the stator teeth 213. In addition, the stator windings 212 may extend axially beyond the longitudinal ends of the stator body 202.

A ratio of an outer diameter of the stator body 202 to an axial length of the stator body 202 (e.g., the distance along the axis A between the body's longitudinal ends not including an extending portion of the stator windings 212) may be, by way of non-limiting example, not less than 1.5 and not greater than 3.5, e.g., in order to satisfy predetermined packing space constraints for a particular application of the motor-generator, such as in the vehicle powertrain of FIG. 1.

The rotor body 204 is disposed about the motor-generator shaft 208 and may be splined, attached, fused, or otherwise rotationally fixed thereto. The rotor body 204 is a laminated structure, which generally defines a truncated right circular cylinder. The rotor body 204 includes a plurality of ferromagnetic components 214 and a curable filler 216. As can be seen, the ferromagnetic components 214, alone or in combination with the curable filler 216, are configured to produce a substantially continuous circular peripheral edge 218 of the rotor body 204. The ferromagnetic components 214 are arranged such that rotor body 204 includes a plurality of flux barriers 220 circumferentially arranged about the motor-generator shaft 208 between the motor-generator shaft 208 and the peripheral edge 218 of the rotor body 204.

The plurality of flux barriers 220 may include a first layer 220A of flux barriers 220 proximate to central portion of the rotor body 204, and a fourth layer 220D of flux barriers 220 proximate the periphery of the rotor body 204. A second layer 220B may be radially interposed between the first layer 220A and a third layer 220C, while the third layer 220C may be radially interposed between the second layer 220B and the fourth layer 220D. One or more flux barrier layers 220A-D may be dimensioned such that a thickness measured perpendicular to the edge 222 is between about 1.5 mm and about 2.5 mm.

The flux barriers 220 have different magnetic properties from at least one adjacent component. For example, the flux barriers 220 may be non-magnetic while the adjacent portions are ferromagnetic. In some aspects, the flux barriers 220 are provided in the form of a generally non-magnetic material disposed between ferromagnetic components 214. In some aspects, the flux barriers 220 or selections thereof include one or more permanent magnets disposed therein. For example, the innermost, first through third layers 220A-220C include or are filled with permanent magnets while the outermost, fourth layer 220D does not include permanent magnets. In further examples, the permanent magnets may be disposed in alternating layers, such as the first layer 220A and the third layer 220C, while the remaining layers do not include permanent magnets.

The ferromagnetic components 214 are formed from a ferromagnetic material configured to provide desired magnetic characteristics. For example, the ferromagnetic material may be electrical steel, iron, nickel, cobalt, combinations thereof, or the like. The laminated structure may be formed by, for example, stacking a plurality of ferromagnetic components 214 along the axis of rotation.

In some aspects, the plurality of ferromagnetic components 214 is a plurality of plates 214A, such as those illustrated in FIG. 3A, and the laminated structure is formed by the plurality of plates 214A being stacked axially along the motor-generator shaft 208 such that each of the plates 214A extends radially therefrom. The plates 214A may be produced by forming, machining, molding, additive manufacturing processes, combinations thereof, and the like. For example, milling, stamping, extruding, metal injection molding, cutting, combinations thereof, and the like may be employed to produce plates having a desired shape or desired shapes.

In some aspects, the plurality of ferromagnetic components 214 is a plurality of members 214B, such as those illustrated in FIG. 3B, and the laminated structure is formed by the plurality of members 214B being arranged radially around the motor-generator shaft 208 and extending at least partially longitudinally therealong. The members 214B may be correspondingly shaped such that assembly of the plurality of members 214B results in the right circular cylinder. The members 214B may be produced by forming, machining, molding, additive manufacturing processes, combinations thereof, and the like. For example, milling, stamping, extruding, metal injection molding, cutting, combinations thereof, and the like may be employed to produce members having a desired shape or desired shapes. In some aspects, the plurality of ferromagnetic components 214 is configured to provide the rotor body 204 with a saliency ratio of about 2 to about 10.

The curable filler 216 is configured to transition from a flowable state to a substantially rigid state in response to curing of the curable filler 216. The curable filler 216 may be an adhesive material providing high flexural strength, minimal void content, and full contact area. In some aspects, the curable filler 216 is an epoxy, a phenol, a silicone, or a polyurethane. For example, epoxies available from Sumitomo Bakelite Co., Ltd., such as SUMIKON® EME and MPC series epoxies, and more particularly SUMIKON® EME-M630 or MPC-4780 epoxies, may be used. In some aspects, the curable filler 216 has magnetic properties selected to strengthen the magnetic field of the rotor body 204.

The curable filler 216 occupies the rotor cavities 224 between the ferromagnetic components 214 and is configured to maintain positions of the ferromagnetic components 214 during rotation of the rotor body 204. In some aspects, the curable filler 216 occupies all rotor cavities 224, while in other aspects, fewer than all rotor cavities 224 are occupied by the curable filler 216.

The curable filler 216 may be applied to the rotor body 204 using, for example, molding techniques such as injection molding or epoxy molding. In some aspects, the curable filler 216 forms an adhesive bond with edges 222 of the rotor cavities 224 to thereby optimize tensile stresses experienced by the ferromagnetic components 214.

Additionally or alternatively, the edges 222 of the rotor cavities 224 may define profiles to provide a mechanical interlock between the curable filler 216 and the ferromagnetic components 214. For example, the edges 222 may include profiles having alternating protruding and recessed portions, such as a saw-tooth profile, crenellated profile, or cleated profile, such that surface-to-surface sliding between respective portions of the ferromagnetic components 214 and the curable filler 216 is inhibited. In further examples, the edges 222 may include profiles having undercut portions, such as dovetail profiles or circular undercuts, such that both surface-to-surface sliding and delamination are inhibited. Beneficially, profiled edges 222 may be formed simultaneously with formation of the ferromagnetic components.

The profile features may be selected to provide desired mechanical properties. For example, the profiles may be rounded to further inhibit stress concentration present in corners of the material. Further, measure of the undercut angles may be minimized to provide lock-in while optimizing neck size and strength. It is contemplated that combinations of profiles may be provided. For example, edges 222 nearer the motor-generator shaft 208 may have a first profile to accommodate stresses experienced nearer the axis of rotation while edges 222 nearer the periphery of the rotor body 204 may have a second profile to accommodate stresses experienced nearer the periphery of the rotor body 204, such as those resulting from increased linear velocity and magnetic interactions with the stator body 202.

The thermal expansion properties of the curable filler 216 within the rotor cavities 224 are configured to approximate thermal expansion properties of the ferromagnetic components 214. In some aspects, the effective coefficient of thermal expansion of the curable filler 216 is approximately equal to the coefficient of thermal expansion of the ferromagnetic components 214. In some aspects, the rotor cavities 224 and/or ferromagnetic components 214 are selectively shaped to mitigate differences in coefficients of thermal expansion for the materials.

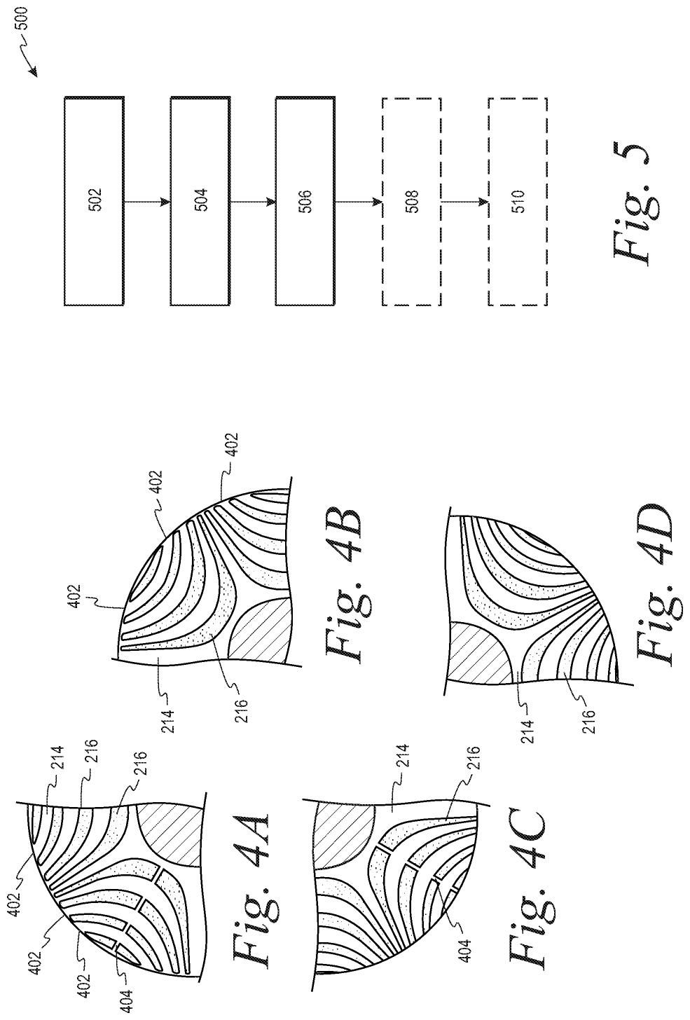

Referring now to FIGS. 4A-D, configurations of ferrous bridges 402 and central posts 404 for example rotor bodies 204 are shown. FIG. 4A illustrates a rotor body 204 with ferrous bridges 402 and central posts 404, FIG. 4B illustrates the rotor body 204 with ferrous bridges 402 only, FIG. 4C illustrates the rotor body 204 with central posts 404 only, and FIG. 4D illustrates the rotor body 204 without ferrous bridges 402 or central posts 404. Each of the ferrous bridges 402 and the central posts 404 contribute to leakage of flux in the rotor magnetic circuit. Beneficially, the ferrous bridges 402 and the central posts 404 of the present disclosure are not responsible for maintaining structural integrity of the rotor body 204 during use of the motor-generator 12. Rather, the ferrous bridges 402 and the central posts 404 of the present disclosure maintain positioning of the ferromagnetic components 214 prior to introduction of the curable filler 216 into the rotor cavities 224.

Because the curable filler 216 provides structural support for the ferromagnetic components 214 during rotation of the rotor body 204, flux-leaking components such as the ferrous bridges 402 and the central posts 404 may be reduced in size to mitigate their effects on magnetic flux. Beneficially, in some aspects, the ferrous bridges 402 and/or central posts 404 are sacrificial components that are removed after the curable filler 216 is cured. In some aspects, the sacrificial components are removed via a mechanical process such as milling. In some aspects, the sacrificial components are a fusible material removed via, for example, chemical or thermal processes.

In some aspects, the rotor body 204 includes an overwrap 226 circumscribing the periphery of the rotor body. The overwrap 226 may be, for example, carbon fiber or other composite wraps. Beneficially, the overwrap 226 may be configured to mitigate differences in thermal expansion between the ferromagnetic components 214 and the curable filler 216.

Rotor bodies 204 according to aspects of the present disclosure provide a number of benefits. For example, rotor bodies as disclosed herein optimize performance of the motor-generator though, for example, (1) strengthened magnetic interactions between the ferromagnetic components of the rotor body and electromagnetic components of the stator body by reducing space between a periphery of rotor body and inner surface of the stator, (2) reducing thickness of or eliminating non-magnetic components disposed between magnetic components of the rotor body and magnetic components of the stator, such as sleeves or wraps, and/or (3) reducing thickness of or eliminating flux-leaking components of the rotor body disposed proximate the stator body. Further, rotor bodies 204 in accordance with the present disclosure provide for an increased number of flux barriers 220 within the same space while maintaining or increasing structural integrity of the rotor body 204. Moreover, efficiency and peak rotational speeds are optimized by the curable filler 216 providing structural integrity to the rotor body 204 and thereby maintaining structural integrity of the rotor body 204 at high RPM. Beneficially, rotor bodies 204 in accordance with the present disclosure further optimize structural integrity during revolution of the rotor body 204 by reducing rotor weight.

FIG. 5 depicts a method 500 of producing a rotor body 204, according to aspects of the present disclosure. The method 500 includes arranging 502 the ferromagnetic components 214 to thereby form a rotor body precursor defining a plurality of channels therein, filling 504 the plurality of channels with the curable filler 216 to thereby form the plurality of flux barriers 220, and curing 506 the curable filler 216 to thereby form the rotor body 204.

Filling 504 the plurality of channels with the curable filler 216 may employ, for example, epoxy molding. Curing 506 the curable filler 216 may include, for example, elevating a temperature of the curable filler 216, applying an initiator (such as ultraviolet light or a chemical component) to the curable filler 216. The rotor body precursor may include ferrous bridges 402 and/or central posts 404 which support the ferromagnetic components 214 and maintain relative positions and sizing of the flux barriers 220 during curing 506 of the curable filler 216.

In some aspects, method 500 further includes removing 508 the ferrous bridges 402 and/or central posts 404 after curing 506 the curable filler 216. The method 500 may yet further include applying 510 an overwrap to the rotor body 204 after removing 508 the ferrous bridges 402 and/or central posts 404.

The illustrated vehicle 10 is an exemplary application with which novel aspects and features of this disclosure may be practiced. As such, it will be understood that aspects and features of the disclosure may be applied to other electric-motor powered applications. While the above-described aspects describe laminated rotor bodies, it is contemplated that benefits of the present disclosure are equally applicable to solid rotor bodies having flux barriers therein. Further, while the above-described aspects describe high-speed synchronous reluctance motor-generators 12, it is contemplated that rotor bodies in accordance with the present disclosure may be used in other motor types. Yet further, while the motor-generator 12 is described with the stator 202 circumscribing the rotor body 204, concepts of the present disclosure are applicable to outer-rotor motor-generators that include a rotor circumscribing the stator.

As used herein, unless the context clearly dictates otherwise: the words “and” and “or” shall be both conjunctive and disjunctive, unless the context clearly dictates otherwise; the word “all” means “any and all” the word “any” means “any and all”; the word “including” means “including without limitation”; and the singular forms “a”, “an”, and “the” includes the plural referents and vice versa.

Words of approximation, such as “approximately,” “about,” “substantially,” and the like, may be used herein in the sense of “at, near, or nearly at,” “within 0-10% of,” or “within acceptable manufacturing tolerances,” or a logical combination thereof, for example.

All numerical values of parameters (e.g., of quantities or conditions) in this specification, unless otherwise indicated expressly or clearly in view of the context, including the appended claims, are to be understood as being modified in all instances by the term “about” whether or not “about” actually appears before the numerical value. The numerical parameters set forth herein and in the attached claims are approximations that may vary depending upon the desired properties sought to be obtained by the present disclosure. At the very least, and not as an attempt to limit the application of the doctrine of equivalents to the scope of the claims, each numerical parameter should at least be construed in view of the number of reported significant digits and by applying ordinary rounding techniques.

While the metes and bounds of the term “about” are readily understood by one of ordinary skill in the art, the term “about” indicates that the stated numerical value or property allows some imprecision. If the imprecision provided by “about” is not otherwise understood in the art with this ordinary meaning, then “about” indicates at least variations that may arise from ordinary methods of measuring and using such parameters. For example, if not otherwise understood in the art, the term “about” means within 10% (e.g., ±10%) of the stated value.

While the metes and bounds of the term “substantially” are readily understood by one of ordinary skill in the art, the term “substantially” indicates that the stated numerical value or property allows some slight imprecision. If the imprecision provided by “substantially” is not otherwise understood in the art with this ordinary meaning, then “substantially” indicates at least variations that may arise from manufacturing processes and measurement of such parameters. For example, if not otherwise understood in the art, the term “substantially” means within 5% (e.g., ±5%) of the stated value.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

1. A rotor body comprising:
a plurality of ferromagnetic components arranged about an axis defining a circular periphery distal to the axis, the plurality of ferromagnetic components defining a plurality of channels arranged circumferentially about the axis; and
a plurality of flux barriers, each of the plurality of flux barriers including a curable filler occupying a respective one of the plurality of channels, the curable filler configured to maintain radial spacing of the plurality of ferromagnetic components and optimize mechanical stress across the rotor body.

2. The rotor body of claim 1, wherein the circular periphery is a continuous circular periphery defined by the ferromagnetic components and the curable filler.

3. The rotor body of claim 1, further comprising a non-magnetic overwrap circumscribing the circular periphery.

4. The rotor body of claim 1, wherein the curable filler is an epoxy, a phenol, a silicone, or a polyurethane.

5. The rotor body of claim 1, wherein at least one of the plurality of flux barriers includes a profiled edge, and the profiled edge provides a mechanical interlock between the curable filler and the ferromagnetic components.

6. The rotor body of claim 5, wherein the profiled edge includes alternating protruding portions and recessed portions.

7. The rotor body of claim 1, further comprising at least one permanent magnet disposed within the curable filler within the plurality of flux barriers.

8. A motor-generator comprising:
a rotor body including a plurality of ferromagnetic components and a plurality of flux barriers, the plurality of ferromagnetic components arranged about an axis defining a circular periphery distal to the axis, the plurality of ferromagnetic components defining a plurality of channels arranged circumferentially about the axis, each of the plurality of flux barriers including a curable filler occupying a respective one of the plurality of channels, the curable filler configured to maintain radial spacing of the plurality of ferromagnetic components and optimize mechanical stress across the rotor body; and
a stator body circumscribing the rotor body.

9. The motor-generator of claim 8, wherein the circular periphery is a continuous circular periphery defined by the ferromagnetic components and the curable filler.

10. The motor-generator of claim 9, further comprising an air gap defined by the continuous circular periphery and the stator body.

11. The motor-generator of claim 8, further comprising an overwrap circumscribing the rotor body and an air gap defined by an outer periphery of the overwrap and an interior of the stator body.

12. A method comprising:
arranging a plurality of ferromagnetic components to thereby form a rotor-body precursor defining a plurality of channels therein;
filling the plurality of channels with a curable filler to thereby form a plurality of flux barriers; and
curing the curable filler to thereby form a rotor body.

13. The method of claim 12, wherein the plurality of ferromagnetic components are suspended, prior to filling the plurality of channels, by one or more of a plurality of ferrous bridges and a plurality of central posts.

14. The method of claim 12, further comprising removing, after curing, a plurality of ferrous bridges disposed about a periphery of the rotor body to thereby produce a continuous circular periphery defined by the ferromagnetic components and the curable filler.

15. The method of claim 12, further comprising applying an overwrap to the rotor body, the overwrap circumscribing and contacting a continuous circular periphery defined by the ferromagnetic components and the curable filler.

16. The method of claim 12, wherein the rotor-body precursor is a laminated rotor-body precursor, and wherein the laminated rotor-body precursor does not include a plurality of ferrous bridges disposed about a periphery.

17. The method of claim 12, further comprising aligning the rotor body with a stator body to define an air gap therebetween.

18. The method of claim 12, wherein the rotor body includes a continuous circular periphery defined by the ferromagnetic components and the curable filler in response to curing the curable filler.

19. The method of claim 12, wherein at least one of the plurality of channels includes a profiled edge, and wherein the profiled edge, in response to curing the curable filler provides a mechanical interlock between the curable filler and the ferromagnetic components.

20. The method of claim 19, wherein the profiled edge includes alternating protruding portions and recessed portions.
